(19) United States
(12) Patent Application Publication
(10) Pub. No.: US 2011/0022445 A1
(43) Pub. Date: Jan. 27, 2011

(54) AIRPORT PROMOTION AND ADVERTISEMENT SYSTEM

(76) Inventors: Conrad R. Carney, II, Lexington, KY (US); James H. Johnson, JR., Lexington, KY (US)

Correspondence Address: KING & SCHICKLI, PLLC, 247 NORTH BROADWAY, LEXINGTON, KY, 40507, US

(21) Appl. No.: 12/841,356

(22) Filed: Jul. 22, 2010

Related U.S. Application Data
(60) Provisional application No. 61/227,560, filed on Jul. 22, 2009.

(51) Int. Cl. G06Q 30/00

(52) U.S. Cl. 705/14.1; 705/14.58

(57) ABSTRACT

A method of promoting businesses at airports includes the step of providing an internet database for access by consumers. The database lists promotional offers of businesses with airport locations. The method further includes sorting the promotional offers by a selected criteria which allows a consumer or customer to more quickly find desired information. Further, the method includes allowing the consumer to access the promotional offers for review and select one or more of the promotional offers for use.

This application claims priority to U.S. Provisional Patent Application Ser. No. 61/227,560 filed 22 Jul. 2009, the entire disclosure of which is incorporated herein by reference.

### TECHNICAL FIELD AND INDUSTRIAL APPLICABILITY OF THE INVENTION

The present invention relates generally to the marketing field and, more particularly, to a method of promoting businesses at airports utilizing mobile phone text messaging.

### BACKGROUND OF THE INVENTION

The marketing of goods and services by means of mobile phone text messaging is a rapidly growing field. The concept of narrow casting text messages to existing or potential business customers is known. Relevant prior art patents include U.S. Pat. Nos. 6,754,314 to Wengrovitz et al, 7,197,324 to Sweeney and 7,437,413 to Okuyama et al.

The present invention relates to a new and improved method of promoting businesses at airports using a mobile phone text messaging service.

### SUMMARY OF THE INVENTION

In accordance with the purposes of the present invention as described herein, a method is provided of promoting businesses at airports. The method comprises providing an internet database for access by consumers. The database lists promotional offers of businesses with airport locations. The method further includes sorting the promotional offers by a selected criteria allowing the consumer to access the promotional offers for review and allowing the consumer to take advantage of one or more of the promotional offers. The offers may be sorted by the business making the promotional offers, by the airport at which the promotional offers are available or even by the goods or services to which the promotional offers relate.

In accordance with an additional aspect of the present invention the method includes allowing the consumer to provide an airline confirmation number or flight number. Upon directing that information to the internet database, all airports are identified through which the consumer is routed. Further, the database identifies all promotional offers available at those airports on the consumer's route.

The method also includes sending coupons for the promotional offers to the consumer. In one embodiment of the invention the method includes using a global positioning satellite system and a mobile communication device such as a mobile telephone of the consumer to determine the presence of the consumer at a particular airport. The coupon or coupons selected by the consumer are then sent to the consumer at the airport through the mobile communication device of the consumer.

In accordance with yet another aspect of the present invention the method includes sending directions to the consumer so that the consumer is better able to find the business located at the airport making the selected promotional offer. By means of the global positioning system and the mobile communication device, it is possible to provide precise directions to the desired destination.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a schematical block diagram broadly illustrating the method of the present invention; and

FIG. 2 is a schematical block diagram illustrating the relationship between the various entities involved in the targeted marketing concept of the present invention.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

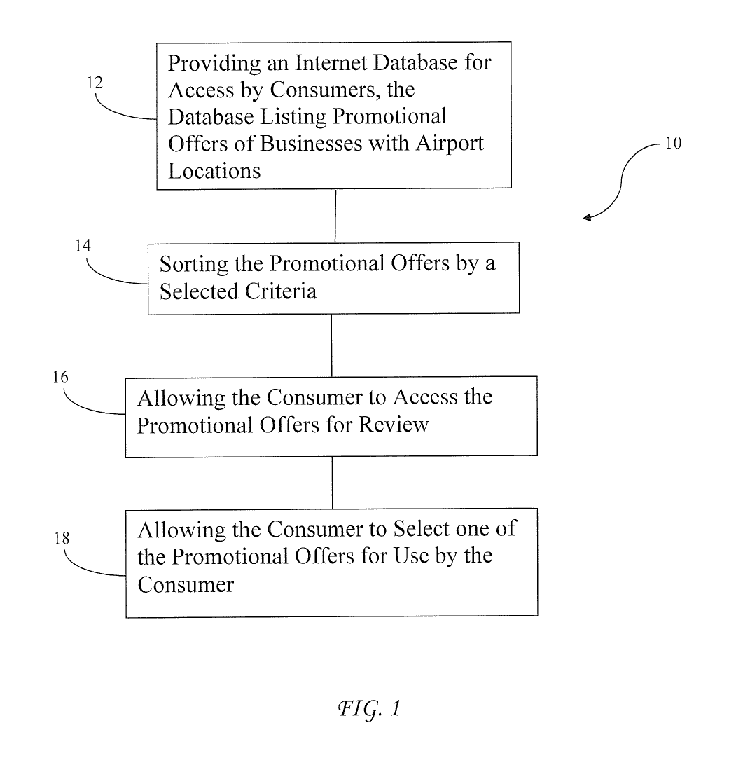

As illustrated in FIG. 1, the present invention relates to a method (10) of promoting businesses at airports that may be broadly described as comprising the steps of (a) providing an internet database for access by consumers, the database listing promotional offers of businesses with airport locations (12); (b) sorting the promotional offers by a selected criteria (14); (c) allowing the consumer to access the promotional offers for review (16); and (d) allowing the consumer to select one of the promotional offers for use by the consumer (18).

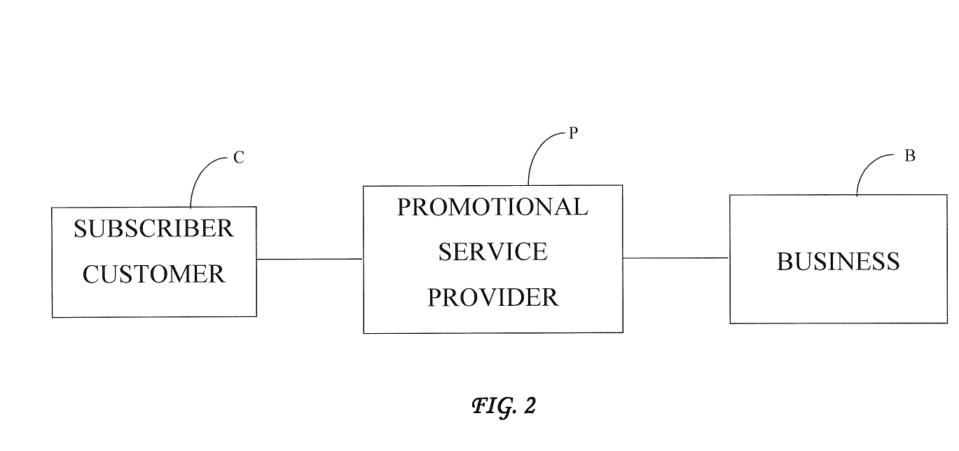

As illustrated in FIG. 2, a promotional service provider P is engaged by an airport business B to promote the business to subscriber customers/consumers C. Toward this end, the promotional service provider P utilizes a mobile phone text messaging service. Such a text messaging service is a permission based service requiring the registration of a customer or potential customer of the business B. Two mediums are provided for a customer C to join or subscribe to the text messaging service. The first provides for customer registration via an internet website. The second provides for customer registration via mobile phone texting. Thus, a potential customer or existing customer C may utilize his mobile phone to register via the cell phone registration medium.

In order to register, a customer C provides personal data which is stored in memory by the promotional service provider P. That data includes, but may not necessarily be limited to, residence information including address and mobile phone number. The individual registering may then review a list of airport businesses represented by the text messaging service. The individual then selects those businesses from which it is desired to receive discounts, coupons and other communication. This activates text messaging services whereby the promotional service provider P provides promotional information, such as coupons, of the business B to the subscriber customer C with pre-authorized customer approval.

Significantly, the available promotional offers may be sorted by selected criteria. For example, the promotional offers may be sorted and the information accessed by the business making the offer. Alternatively or in addition, the promotional offers may be sorted and accessed by airport location. Alternatively or in addition, the promotional offers may be sorted and accessed by the goods or services offered. For example, a subscriber customer C may want to access all coupons/promotional offers being made by restaurants at Standiford Field in Louisville, Ky.

In yet another embodiment, the internet database includes flight information. Thus, a customer C may simply enter an airline confirmation number or flight number and the database will display promotional offers available at all airports on the travel route of the customer C for the customer's days of travel.

All customers C taking advantage of a business promotion are then maintained on a list by the promotional service provider P. The system also provides a business B with an indication of how many times a particular individual or customer C has taken advantage of a coupon or special offer of the business sent by text message. Thus, the list represents valuable marketing information stored by the promotional service provider P. This greatly increases the value of the service provided by the promotional service provider P and the business B is provided with an incentive to maintain the service.

If desired, it should be appreciated that the targeted marketing may be made location specific: that is, promotional material for the business B may be sent to the subscriber customer C only when the subscriber customer is located at the airport where the promotional offer is in effect. Thus, in accordance with an additional significant aspect of the present invention, the mobile phone text messaging service provided by the promotional service provider P may include a global positioning satellite monitor. The global positioning satellite (GPS) monitor locates the individual subscriber customer or potential customer C by monitoring the global positioning satellite or GPS feature of the mobile phone carried by that customer. Once the individual customer C reaches a particular airport on his or her travel route, the promotional service provider P sends a communication to the individual customer C specific for that airport. Thus, for example, if the customer C has selected a discount coupon for a lunch meal at a particular airport restaurant, that coupon is sent via text message to the customer's mobile telephone when the monitor detects the presence of that customer's telephone at the airport where the restaurant is located. The customer can then display the coupon on the screen of the mobile telephone when ordering food in order to redeem the coupon and receive a price discount. Such a paperless coupon system is particularly convenient when one is traveling.

In one particularly useful embodiment of the invention, the promotional service provider P sends directions to the customer C to insure the customer reaches the restaurant and doesn't get lost in the airport. More specifically, the GPS monitor identifies the exact location of the customer C at the airport. The best route to the selected restaurant is then determined. Next the route information/directions to the restaurant are sent via text message to the customer C via the customer's mobile telephone. The route information/directions may be updated periodically as the customer moves toward the restaurant. This represents a particularly valuable convenience feature when traveling through an unfamiliar and crowded airport.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A method of promoting businesses at airports, comprising:
providing an internet database for access by consumers, said database listing promotional offers of businesses with airport locations;
sorting said promotional offers by a selected criteria;
allowing said consumer to access said promotional offers for review;
allowing said consumer to select one of said promotional offers for use by said consumer.

2. The method of claim 1, including sorting said promotional offers by business making said promotional offer.

3. The method of claim 1, including sorting said promotional offers by airport at which said promotional offers are available.

4. The method of claim 1, including sorting said promotional offers by goods or services for which said promotional offers relate.

5. The method of claim 1, allowing said consumer to provide an airline confirmation number or flight number to identify all airports through which said consumer is routed and identify all promotional offers available at said airports on said consumers route.

6. The method of claim 1, including sending coupons for said promotional offers to said consumer.

7. The method of claim 1, including using a global positioning satellite system in a mobile communication device of a consumer to determine presence of said consumer at a particular airport and then sending coupons for said selected promotional offer at said airport to said mobile communications device of said consumer.

8. The method of claim 7, including sending directions to said consumer so that said consumer is able to better find a business located at said airport making said selected promotional offer.
